(19) United States
(12) Patent Application Publication
(10) Pub. No.: US 2013/0115836 A1
(43) Pub. Date: May 9, 2013

(54) COMPOSITE POLYAMIDE ARTICLE

(71) Applicants: Franck Touraud, Eyzin Pinet (FR); Gilles Orange, Vourles (FR); Stéphane Jeol, Lyon (FR); Roland Durand, Saint Bonnet de Mure (FR)

(72) Inventors: Franck Touraud, Eyzin Pinet (FR); Gilles Orange, Vourles (FR); Stéphane Jeol, Lyon (FR); Roland Durand, Saint Bonnet de Mure (FR)

(73) Assignee: RHODIA OPERATIONS, Aubervilliers (FR)

(21) Appl. No.: 13/698,512

(22) PCT Filed: May 17, 2011
(86) PCT No.: PCT/EP2011/057934

§ 371 Date: Jan. 18, 2013

(30) Foreign Application Priority Data
May 17, 2010 (FR) 10/53779

(51) Int. Cl. C09D 177/06; D06N 3/12; B29C 45/14

(52) U.S. Cl. CPC C09D 177/06; B29C 45/14; D06N 3/125
USPC 442/59; 427/398.1; 264/257

(57) ABSTRACT

The use of a polyamide modified by hydroxyl aromatic compounds used to impregnate reinforcement materials assuming the form of industrial fabric cloth for manufacturing composite materials is described. Also described, is a composite material produced and a method by which the composite material is produced. Further, the method by which the composite material is produced can include:

a) impregnating a reinforcing cloth with a polyamide composition in a molten state, the polyamide including hydroxy aromatic units which are chemically linked to the polyamide chain; the composition including a novolac resin; and

b) cooling and then recovering the composite article.

The present invention relates to the use of polyamide modified by hydroxyaromatic compounds employed in the impregnation of reinforcing materials taking the form of cloth of industrial fabrics for the manufacture of composite materials. The field of the invention is that of composite materials and of their manufacturing processes. The invention also relates to a process for the manufacture of a composite article comprising at least:
a) a stage of impregnation of a reinforcing cloth with a polyamide composition in the molten state, said polyamide comprises hydroxyaromatic units chemically bonded to the chain of the polyamide, the composition comprising a novolac resin;
b) a stage of cooling and subsequently of recovering the composite article.

### PRIOR ART

In the field of high-performance materials, composites have assumed a dominating position because of their performance and the savings in weight which they allow. The currently most well known high-performance composites are obtained from thermosetting resins, use of which is limited to small-scale to moderate-scale applications, mainly in aeronautics or motor sports, and, in the best cases, which exhibit manufacturing times in the region of approximately fifteen minutes, such as, for example, during the manufacture of skis. The cost of these materials and/or the manufacturing times make it difficult to render them compatible with use in mass production. Furthermore, the use of thermosetting resins often involves the presence of solvents and of monomers. Finally, these composites are difficult to recycle.

Thermoplastic polymers are generally known for their high viscosity, which constitutes a check as regards the impregnation of the reinforcing materials, generally composed of very dense multifilament bundles. The use of the thermoplastic matrices available on the market results in a difficulty in impregnation, requiring either prolonged impregnation times or significant processing pressures. In the majority of cases, the composite materials obtained from these matrices may exhibit microspaces and unimpregnated regions. These microspaces bring about declines in mechanical properties, premature aging of the material and problems of delamination when the material is composed of several reinforcing layers. This phenomenon of loss of mechanical properties is furthermore accentuated when the cycle times for the manufacture of the composite articles decrease.

Another problem frequently encountered with composite materials comprising a polymer matrix is their resistance to aging and more particularly to hygrothermal aging. The diffusion of water within composite materials results in a substantial modification of certain physical characteristics, such as, for example, the glass transition temperature, or a swelling of the matrix. A modification at the matrix/fibers interfaces may also be observed, generally with an irreversible nature. This aging is expressed by a deterioration in the mechanical performance, in particular the ultimate strength. It is then necessary to oversize the components, which results in an increase in weight and a not insignificant additional expenditure.

The object of the present invention is thus to overcome these disadvantages by providing a composite article which can be manufactured with short cycle times while having good use properties, such as good mechanical properties, and good resistance to hygrothermal aging.

### INVENTION

The Applicant Company has discovered, unexpectedly, that the use of polyamide resins modified by hydroxyaromatic compounds in the manufacture of composite articles makes it possible to obtain articles exhibiting not only good mechanical properties, such as in particular stiffness, ultimate strength, impact strength and fatigue behavior, even when they are manufactured with shorter cycle times than those normally used and without any other treatment, but also good resistance to hygrothermal aging. This makes it possible to provide a composite material exhibiting both an advantage of reduction in manufacturing costs, by the use of equipment employing shortened cycle times, and also sufficient durability for structural applications. The composite articles according to the present invention also exhibit a low water uptake and a good dimensional stability.

These composite articles exhibit in particular very good maintenance of the mechanical properties after hygrothermal aging, in particular in comparison with conventional polyamide composite articles.

The articles according to the invention exhibit in particular the advantages of stiffness, lightness and ability to be recycled, and a good surface appearance.

These articles also exhibit good flame-retardancy properties.

A first subject matter of the invention is a process for the manufacture of a composite article comprising at least:
a) a stage of impregnation of a reinforcing cloth with a polyamide composition in the molten state, said polyamide comprises hydroxyaromatic units chemically bonded to the chain of the polyamide, the composition comprising at least one novolac resin;
b) a stage of cooling and subsequently of recovering the composite article.

The present invention also relates to a composite article comprising at least one reinforcing cloth and one modified polyamide comprising hydroxyaromatic units chemically bonded to the chain of the polyamide, and one novolac resin.

Cloth is understood to mean a textile surface of yarns or fibers which are optionally rendered integral by any process, such as, in particular, adhesive bonding, felting, braiding, weaving or knitting. These cloths are also denoted as fibrous or filamentary networks. Yarn is understood to mean a monofilament, a continuous multifilament yarn or a staple fiber yarn obtained from fibers of a single type or from several types of fibers as an intimate mixture. The continuous yarn can also be obtained by assembling several multifilament yarns. Fiber is understood to mean a filament or a combination of filaments which are cut, cracked or converted.

The reinforcing yarns and/or fibers according to the invention are preferably chosen from yarns and/or fibers formed of carbon, glass, aramids, polyimides, flax, hemp, sisal, coir, jute, kenaf and/or their mixture. More preferably, the reinforcing cloths are composed solely of reinforcing yarns and/or fibers chosen from yarns and/or fibers formed of carbon, glass, aramids, polyimides, flax, hemp, sisal, coir, jute, kenaf and/or their mixture.

These cloths preferably have a grammage, that is to say the weight per square meter, of between 100 and 1000 g/m².

Their structure may be random, unidirectional (1D) or multidirectional (2D, 2.5D, 3D or other).

A composite article according to the invention can comprise several reinforcing cloths which are identical or different in nature.

The cloths can optionally be coated or sized, in particular in order to introduce specific functional features.

The polyamide according to the invention advantageously exhibits a melt viscosity η of less than 250 Pa·s, preferably between 1 and 50 Pa·s. This viscosity can be measured using a plate/plate rheometer with a diameter of 50 mm under a stepwise shear sweep ranging from 1 to 160 s⁻¹. The polymer is in the form of a film with a thickness of 150 μm, of granules or of powder. The polymer is brought to a temperature of 25 to 30° C. above its melting point and the measurement is then carried out.

The number-average molecular weight (Mn) of the polyamides is preferably greater than 6000 g/mol, more preferably between 8000 g/mol and 20 000 g/mol, having satisfactory mechanical properties and a degree of hold during various shaping processes.

Semicrystalline polyamides are particularly preferred.

The present invention relates in particular to a polyamide modified by a compound comprising at least one aromatic hydroxyl group chemically bonded to the polymer chain, it being possible for this polyamide to be obtained by polymerization, apart from the monomers of the polyamide, of a hydroxyaromatic compound or by melt blending a polyamide, partially or completely formed, with a hydroxyaromatic compound, in particular during a reactive extrusion. The modified polyamide according to the invention can also be obtained by solid-phase or solvent-phase polycondensation for some polyamides.

The monomers of the polyamides can in particular be diacid monomers, in particular aliphatic, cycloaliphatic, arylaliphatic or aromatic diacid monomers, diamine monomers, in particular aliphatic diamine monomers, and/or amino acids or lactams. These are generally the monomers conventionally used for the manufacture of semicrystalline polyamides, such as aliphatic polyamides, semiaromatic polyamides and more generally the linear polyamides obtained by polycondensation between a saturated aliphatic or aromatic diacid and a saturated aromatic or aliphatic primary diamine, the polyamides obtained by condensation of a lactam or of an amino acid or the linear polyamides obtained by condensation of a mixture of these various monomers. More specifically, these copolyamides can be, for example, poly(hexamethylene adipamide), the polyphthalamides obtained from terephthalic and/or isophthalic acid, or the copolyamides obtained from adipic acid, hexamethylene-diamine and caprolactam.

The monomers of the polyamides can optionally comprise unsaturations or heteroatoms, such as oxygen, sulfur or nitrogen.

Use may in particular be made of the polyamides chosen from the group consisting of polyamide 6, polyamide 6.6, polyamide 6.10, polyamide 11, polyamide 12, polyamide 6.12, poly(m-xylylene adipamide) (MXD6), polyamide 6.6/6.T, polyamide 6.6/6.I, and the blends and copolyamides, such as copolyamide 6.6/6, for example. The composition of the invention can also comprise the copolyamides derived in particular from the above polyamides or the blends of these polyamides or copolyamides.

The preferred polyamides are poly(hexamethylene adipamide), polycaprolactam, or the copolymers and blends between poly(hexamethylene adipamide) and polycaprolactam.

The dicarboxylic acids can also be chosen from glutaric acid, adipic acid, pimellic acid, suberic acid, azelaic acid, sebacic acid, dodecanedioic acid, 1,2- or 1,3-cyclohexanedicarboxylic acid, 1,2- or 1,3-phenylenediacetic acid, 1,2- or 1,3-cyclohexanediacetic acid, isophthalic acid, terephthalic acid, 4,4′-benzo-phenonedicarboxylic acid, 2,5-naphthalenedicarboxylic acid and p-(t-butyl)isophthalic acid. The preferred dicarboxylic acid is adipic acid.

The diamines can, for example, be chosen from hexamethylenediamine, butanediamine, pentanediamine, 2-methylpentamethylenediamine, 2-methylhexamethylene-diamine, 3-methylhexamethylenediamine, 2,5-dimethyl-hexamethylenediamine, 2,2-dimethylpentamethylene-diamine, nonanediamine, decanediamine, 5-methyl-nonanediamine, dodecamethylenediamine, 2,2,4- and 2,4,4-trimethylhexamethylenediamine, 2,2,7,7-tetra-methyloctamethylenediamine, isophoronediamine, diamino-dicyclohexylmethane and C₂-C₁₆ aliphatic diamines which can be substituted by one or more alkyl groups. The preferred diamine is hexamethylenediamine.

The modified polyamide of the invention can be obtained from in particular a lactam monomer or an amino acid, preferably one which is aliphatic. Mention may be made, as examples of such lactams or amino acids, of caprolactam, 6-aminohexanoic acid, 5-aminopentanoic acid, 7-aminoheptanoic acid, 11-aminoundecanoic acid or dodecanolactam.

These polyamides can in particular be modified by difunctional or monofunctional monomers, such as, in particular, diacids or diamines or monoacids or monoamines. Polyfunctional molecules, at least trifunctional molecules, can also be used to introduce branchings into the polyamide. Mention will be made, for example, of bishexamethylenetriamine.

Polyamides according to the invention can also be obtained by blending, in particular melt blending, polyamides with monomers which modify the length of the chains, such as, in particular, diamines, dicarboxylic acids, monoamines and/or monocarboxylic acids.

The composition of the invention can also comprise copolyamides derived in particular from the above polyamides, or the blends of these polyamides or (co)polyamides.

Use may also be made, as polyamide of high melt flow, of a star polyamide comprising star macromolecular chains and, if appropriate, linear macromolecular chains.

The polyamide possessing a star structure is a polymer comprising star macromolecular chains and, optionally, linear macromolecular chains. The polymers comprising such star macromolecular chains are, for example, described in the documents FR 2 743 077, FR 2 779 730, EP 0 682 057 and EP 0 832 149. These compounds are known to exhibit an improved melt flow in comparison with linear polyamides.

The star macromolecular chains comprise a core and at least three polyamide branches. The branches are bonded to the core by a covalent bond, via an amide group or a group of another nature. The core is an organic or organometallic chemical compound, preferably a hydrocarbon compound optionally comprising heteroatoms and to which the branches are connected. The branches are polyamide chains. The polyamide chains constituting the branches are preferably of the type of those obtained by polymerization of lactams or amino acids, for example of polyamide-6 type.

The polyamide possessing a star structure according to the invention optionally comprises, in addition to the star chains, linear polyamide chains. In this case, the ratio by weight of the amount of star chains to the sum of the amounts of star chains and of linear chains is between 0.5 and 1, limits included. It is preferably between 0.6 and 0.9.

Carboxylic acid is understood to mean carboxylic acids and their derivatives, such as acid anhydrides, acid chlorides, amides or esters.

Processes for producing these star polyamides are described in the documents FR 2 743 077 and FR 2 779 730. These processes result in the formation of star macromolecular chains, as a mixture with, optionally, linear macromolecular chains.

The composition according to the invention preferably exhibits from 30 to 75% by volume, of polyamide, with respect to the total weight of the composition, preferably from 35 to 60% by volume.

The hydroxyaromatic compound is a compound carrying at least one, in particular one or two, functional groups capable of reacting with the amine or acid functional groups of the polyamide or polyamide monomers.

The term “aromatic hydroxyl group” is understood to mean a hydroxyl functional group attached to a carbon atom forming part of an aromatic ring.

The term “hydroxyaromatic compound” is understood to mean an organic compound comprising at least one aromatic hydroxyl group.

The term “chemically bonded” is understood to mean bonded via a covalent bond. Once chemically bonded to the polyamide chain, the hydroxyaromatic compound becomes a hydroxyaromatic unit and the modified polyamide of the invention is a polyamide comprising hydroxyaromatic units.

The functional groups of the hydroxyaromatic compound which can react with the functional groups of the polyamide are in particular acid, ketone, amine and aldehyde functional groups.

The term “acid functional group” is understood to mean a carboxylic acid functional group or a functional group derived from a carboxylic acid functional group, such as acid chloride, acid anhydride, amide or ester.

The aromatic hydroxyl groups of the invention are not regarded as functional groups which react with acid functional groups.

Advantageously, the hydroxyl group of the monomer is not hindered, that is to say, for example, that the carbon atoms situated in the α position with respect to the hydroxyl functional group are preferably not substituted by bulky substituents, such as branched alkyls.

The hydroxyaromatic compound can, for example, be represented by the following formula (I):

(HO)ₓ—Z—(F)ₙ (I)

in which:
Z is a polyvalent (at least divalent) aromatic or arylaliphatic hydrocarbon radical,
x is between 1 and 10,
F is an acid, aldehyde, amine or ketone functional group capable of becoming bonded to an acid or amine functional group of the monomers of the polyamide, and
n is between 1 and 5.

Z can, for example, be chosen from the group consisting of: benzene, methylbenzene, naphthalene, biphenyl, diphenyl ether, diphenyl sulfide, diphenyl sulfone, ditolyl ether, xylylene, diethylbenzene and pyridine.

The term “arylaliphatic radical” is understood to mean a radical according to which at least one functional group F of the compound of formula (I) is not attached to this radical via a carbon atom forming part of an aromatic ring.

Advantageously, Z comprises between 6 and 18 carbon atoms.

A hydroxyaromatic compound can certainly comprise several types of functional groups F which are different in nature.

This compound is preferably chosen from the group consisting of: 2-hydroxyterephthalic acid, 5-hydroxyisophthalic acid, 4-hydroxyisophthalic acid, 2,5-dihydroxyterephthalic acid, 4-hydroxyphenylacetic acid or gallic acid, L-tyrosine, 4-hydroxyphenylacetic acid, 3,5-diaminophenol, 5-hydroxy-m-xylylenediamine, 3-aminophenol, 3-amino-4-methylphenol and 3-hydroxy-5-aminobenzoic acid.

In the context of the invention, mixtures of different compounds of formula (I) can be employed.

The molar proportion of hydroxyaromatic compound, with respect to all the monomers forming the polyamide, for example the sum of the diacid, diamine and amino acid monomers and the hydroxyaromatic compound, is generally between 0.1 and 100%, preferably between 1 and 70%, more preferably between 0.5 and 60% and more preferably still between 2.5 and 50%.

The polyamide of the invention is obtained in particular by a process for the melt polymerization of the various monomers described above, these monomers being present in all or in part.

The expression “melt polymerization” is understood to mean that the polymerization is carried out in the liquid state and that the polymerization medium does not comprise a solvent other than water, optionally. The polymerization medium can, for example, be an aqueous solution comprising the monomers or a liquid comprising the monomers. Advantageously, the polymerization medium comprises water as solvent. This facilitates the stirring of the medium and thus its homogeneity. The polymerization medium can also comprise additives, such as chain-limiting agents. The modified polyamide of the invention is generally obtained by polycondensation between the various monomers, present in all or in part, in order to form polyamide chains, with formation of the elimination product, in particular water, a portion of which may be vaporized. The modified polyamide of the invention is generally obtained by heating, at high temperature and high pressure, for example an aqueous solution comprising the monomers or a liquid comprising the monomers, in order to evaporate the elimination product, in particular the water (present initially in the polymerization medium and/or formed during the polycondensation), while preventing any formation of solid phase in order to prevent the mixture from setting solid.

The polycondensation reaction is generally carried out at a pressure of approximately 0.5-3.5 MPa (0.5-2.5 MPa) at a temperature of approximately 100-320° C. (180-300° C.). The polycondensation is generally continued in the molten phase at atmospheric or reduced pressure, so as to achieve the desired degree of progression.

The polycondensation product is a molten polymer or prepolymer. It can comprise a vapor phase essentially composed of vapor of the elimination product, in particular of water, capable of having been formed and/or vaporized.

This product can be subjected to stages of separation of vapor phase and of finishing in order to achieve the desired degree of polycondensation. The separation of the vapor phase can, for example, be carried out in a device of cyclone type. Such devices are known.

The finishing consists in keeping the polycondensation product in the molten state, under a pressure in the vicinity of atmospheric pressure or under reduced pressure, for a time sufficient to achieve the desired degree of progression. Such an operation is known to a person skilled in the art. The temperature of the finishing stage is advantageously greater than or equal to 100° C. and in all cases greater than the temperature at which the polymer solidifies. The residence time in the finishing device is preferably greater than or equal to 5 minutes.

The polycondensation product can also be subjected to a solid-phase postcondensation stage. This stage is known to a person skilled in the art and makes it possible to increase the degree of polycondensation to a desired value.

The process of the invention is similar in its conditions to the conventional process for the preparation of polyamide of the type of those obtained from dicarboxylic acids and diamines, in particular to the process for the manufacture of polyamide 6.6 from adipic acid and hexamethylenediamine. This process for the manufacture of polyamide 6.6 is known to a person skilled in the art. The process for the manufacture of polyamide of the type of those obtained from dicarboxylic acids and diamines generally uses, as starting material, a salt obtained by mixing a diacid with a diamine in a stoichiometric amount, generally in a solvent, such as water. Thus, in the manufacture of poly(hexamethylene adipamide), the adipic acid is mixed with hexamethylenediamine, generally in water, in order to obtain hexamethylenediammonium adipate, better known under the name of Nylon salt or “N Salt”.

Thus, when the process of the invention employs a diacid and a diamine, these compounds can be introduced, at least in part, in the form of a salt. In particular, when the diacid is adipic acid and the diamine is hexamethylenediamine, these compounds can be introduced, at least in part, in the N salt form. This makes it possible to have a stoichiometric equilibrium. Likewise, when the hydroxyaromatic compound is a diacid or a diamine, it is also possible to introduce it in the form of salts with a diamine or a diacid.

The process of the invention generally results in a random polymer when the hydroxyaromatic compound is polyfunctional, in particular at least difunctional, and in a polyamide having partially or completely hydroxyaromatic endings, when the hydroxyaromatic compound is monofunctional.

The modified polyamide obtained at the end of the finishing stage can be cooled and formed into granules.

The modified polyamide obtained by the process of the invention in the molten form can be directly formed or can be extruded and granulated for subsequent forming after melting.

The modified polyamide according to the invention can be used as matrix, alone or in combination with other thermoplastic polymers, in particular polyamides, polyesters or polyolefins.

The polyamide composition according to the invention is used in particular as matrix, in particular by granulation, calendering, extrusion in the film form, grinding, injection, molding, injection molding, pressing, and others.

The stage of impregnation of the polyamide composition of the invention and of the reinforcing cloth can be carried out in various ways, according to various possible processes. It is entirely possible to impregnate one or more reinforcing cloths.

It is possible, for example, to inject the molten polyamide composition into a molding chamber comprising at least one or more reinforcing cloths. The interior of the molding chamber is at a temperature of plus or minus 50° C. with respect to the melting point of said polyamide. It is possible subsequently to cool the molding chamber and the article obtained, in order finally to recover said article. This process is also known, under the name of resin transfer molding (RTM) process, as a thermoset process, which consists in injecting resin into a closed mold in which reinforcing fibers have been placed beforehand. This process can be carried out under pressure.

It is also possible to produce a composite article according to the invention by a film stacking process, which consists of a temperature compression of a stack of reinforcing cloths and polyamide films. In particular, one or more reinforcing cloths and one or more films of polyamide modified by hydroxyaromatic compounds are brought into contact and the cloths are impregnated by melting the polyamide. The pressures necessary for good assembling are generally greater than 30 bar.

The composite article according to the invention can also be prepared by bringing one or more reinforcing cloths into contact with powder of a polyamide as defined above, in particular fine powder, and said impregnation is carried out by melting the polyamide at a temperature equal to or greater than that of the melting point of the polyamide, optionally under pressure.

The composite article of the invention can also be produced by pultrusion. This technique generally consists in drawing one or more continuous yarns and fibers through a heated die so as to impregnate it with a molten thermoplastic resin to obtain a finished or semifinished rod or article.

After the impregnation of the reinforcing cloth by the polyamide, the article is obtained by solidifying the matrix. Cooling can advantageously be carried out rapidly, so as to prevent significant crystallization of the polyamide, in particular in order to maintain the properties of the article. Cooling can in particular be carried out in less than 5 minutes, more preferably in less than 1 minute. The mold can, for example, be cooled by a circuit of cold fluid. It is also optionally possible to transfer the composite article into a cold mold, optionally under pressure.

The polyamide composition and/or the composite article according to the invention can also comprise all the additives normally used in polyamide-based compositions used for the manufacture of articles. Thus, mention may be made, as examples of additives, of heat stabilizers, UV stabilizers, antioxidants, lubricants, pigments, dyes, plasticizers, reinforcing fillers, agents which modify the impact strength, and coupling agents.

Additives for improving the quality of the reinforcing cloths/polyamide interfaces can also be used. These additives can, for example, be incorporated in the polyamide composition, incorporated in the yarns and/or fibers of the reinforcing cloth, present on the yarns and/or fibers of said cloth or deposited on the reinforcing cloth. These additives can be coupling agents, such as those of aminosilane or chlorosilane type, or liquefying or wetting agents, or their combination.

Reinforcing fillers can be incorporated in the polyamide composition. These fillers can be chosen from fibrous fillers, such as short glass fibers, for example, or nonfibrous fillers, such as kaolin, talc, silica, mica or wollastonite. Their size is generally between 1 and 25 μm. Submicronic, indeed even nanometric, fillers can also be used, alone or supplementing the other fillers.

The polyamide composition comprises a novolac resin. It can comprise one or more different types of novolac resin.

The term “novolac resin” is generally understood to mean a phenolic resin which has a formaldehyde/phenol ratio of less than 1 and which, for this reason, normally remains thermoplastic until it has been heated with an appropriate amount of a compound, for example formaldehyde or hexamethylenetetramine, capable of giving additional bonds and consequently of giving an infusible product.

Novolac resins generally condensation products of phenolic compounds with aldehydes or ketones. These condensation reactions are generally catalyzed by an acid or a base. Novolac resins generally exhibit a degree of condensation of between 2 and 15.

The phenolic compounds can be chosen, alone or as a mixture, from phenol, cresol, xylenol, naphthol, alkylphenols, such as butylphenol, tert-butylphenol, isooctylphenol, nitrophenol, phenylphenol, resorcinol or bisphenol A; or any other substituted phenol.

The aldehyde most frequently used is formaldehyde. However, it is possible to use other aldehydes, such as acetaldehyde, paraformaldehyde, butyraldehyde, crotonaldehyde, glyoxal, and furfural. Use may be made, as ketone, of acetone, methyl ethyl ketone or acetophenone. The aldehyde and/or the ketone can optionally carry another functional group, such as, for example, a carboxylic acid functional group. Mention may in particular be made, to this end, of glyoxylic acid or levulinic acid.

According to a specific embodiment of the invention, the novolac resin is a condensation product of phenol and formaldehyde.

The novolac resins used advantageously have a molecular weight of between 500 and 3000 g/mol, preferably between 800 and 2000 g/mol.

Mention may in particular be made, as commercial novolac resin, of the commercial products Durez®, Vulkadur® or Rhenosin®.

The composition according to the invention can comprise between 1 and 20% by weight of novolac resin, in particular from 1 to 10% by weight, with respect to the total weight of the composition.

The present invention relates to an article capable of being obtained by the process of the invention. The article can in particular be a polyamide-based composite article comprising a reinforcing cloth, in which the polyamide exhibits a melt viscosity η of between 1 and 50 Pa·s.

The articles according to the invention preferably comprise between 25 and 80% by volume of reinforcing cloth, with respect to the total weight.

The articles of the invention can be finished or semi-finished articles which can also be referred to as preimpregnated articles. It is possible, for example, to carry out the thermoforming of the composite articles in the form of sheets in order to give them a defined shape after cooling. The invention thus relates to composite articles or preforms capable of being obtained by the process according to the present invention.

The articles of the invention can also be structures of sandwich type exhibiting a core inserted between two skins. The composites of the invention can be used to form external layers, by combining them with a core of honeycomb type or foam type. The layers can be assembled by chemical or heat bonding.

The composite structures according to the invention can be employed in numerous fields, such as the aeronautical, motor vehicle, energy, electrical or sports and leisure industries. These structures can be used to produce sports equipment, such as skis, or else to produce various surfaces, such as special floors, partitions, vehicle bodies or billboards. In aeronautics, these structures are used in particular for fairings (fuselage, wing, tailplane). In the motor vehicle industry, they are used, for example, for floors or supports, such as parcel shelves, or as structural components.

A specific language is used in the description so as to facilitate understanding of the principle of the invention. Nevertheless, it should be understood that no limitation on the scope of the invention is envisaged by the use of this specific language. Modifications and improvements can in particular be envisaged by a person conversant with the technical field concerned on the basis of his own general knowledge.

The term and/or includes the meanings and, or and all the other possible combinations of the elements connected to this term.

Other details or advantages of the invention will become more clearly apparent in the light of the examples given below purely by way of indication.

### EXPERIMENTAL PART

Contents of acid end groups (CEG) and amine end groups (AEG): assayed by potentiometry, expressed in meq/kg. The contents of phenol end groups PEG (for the monofunctional hydroxyaromatic compounds) are determined from the starting amounts of reactants introduced into the synthesis reactor.

Number-average molar mass determined by the formula Mn=2×10⁶/(AEG+CEG+PEG) and expressed in g/mol.

Melting point (M.p.) and associated enthalpy (ΔHf), crystallization temperature on cooling (Tc): determined by differential scanning calorimetry (DSC) using a Perkin Elmer Pyris 1 device, at a rate of 10° C./min.

Glass transition temperature (Tg) determined on the same device at a rate of 40° C./min.

These polyamides were characterized by melt viscosity measurements carried out on an Ares plate/plate rheometer (Rheometrics) at 280° C. The curves of viscosity as a function of the shear rate show that the polymers under consideration have a Newtonian behavior in the shear rate range between 1 and 150 s⁻¹: the viscosity selected is the value at the plateau (between 1 and 150 s⁻¹).

The reinforcements used in the examples are in the form of preforms made of glass fabrics, cut to the dimensions required for the manufacture of the plaques, that is to say 150×150 mm or 200×300 mm. The reinforcing cloth used is a fabric made of glass fiber) (0° -90°) from Synteen & Luckenhaus resulting from a roving of 1200 tex, exhibiting a grammage of 600 g/m2.

The comparative polyamide C1 used in the examples is a high-melt-flow polyamide 6.6 having a viscosity number VN of 97 ml/g, a melt viscosity η of 30 Pa·s and an Mn of 11 200 g/mol.

### EXAMPLE 1

### Preparation of a Copolyamide PA 6.6/6.HIA, 95/5 Molar or 94.2/5.8 by Weight

87.3 kg (332.8 mol) of N salt (1:1 salt of hexamethylenediamine and adipic acid), 3219 g of 99.5% 5-hydroxyisophthalic acid (HIA) (17.5 mol), 6276 g of a 32.4% by weight solution of hexamethylenediamine (HMD) in water (17.5 mol), 81.2 kg of demineralized water and 6.4 g of antifoaming agent Silcolapse 5020® are introduced into a polymerization reactor.

The copolyamide is manufactured according to a standard polymerization process of polyamide 6.6 type, with finishing for 35 minutes.

The polymer obtained is cast in the rod form, cooled and formed into granules by cutting the rods.

The polymer obtained exhibits the following characteristics: CEG=78.4 meq/kg, AEG=57.6 meq/kg, Mn=14 700 g/mol.

The copolyamide is semicrystalline and has the following thermal characteristics:
Tg=76.8° C., Tc=218.4° C., M.p.=256.2° C., ΔHf=62.5 J/g. The copolyamide has a Tg which is greater by 6.2° C. with respect to that of PA 6.6.

### EXAMPLE 2

### Preparation of a Copolyamide PA 6.6/6.HIA, 85/15 Molar or 83/17 by Weight

76.9 kg (293.1 mol) of N salt (1:1 salt of hexamethylenediamine and adipic acid), 9462 g of 99.5% 5-hydroxyisophthalic acid (HIA) (51.7 mol), 18 624 g of a 32.25% by weight solution of hexamethylenediamine (HMD) in water (51.7 mol), 72.6 kg of demineralized water and 6.4 g of antifoaming agent Silcolapse 5020® are introduced into a polymerization reactor.

The copolyamide is manufactured according to a standard polymerization process of polyamide 6.6 type, with finishing for 35 minutes.

10

The polymer obtained is cast in the rod form, cooled and formed into granules by cutting the rods.

The polymer obtained exhibits the following characteristics: CEG=82.7 meq/kg, AEG=61.5 meq/kg, Mn=13 870 g/mol.

The copolyamide is semicrystalline and has the following thermal characteristics:
Tg=85.8° C., Tc=186.2° C., M.p.=240.4° C., ΔHf=41.9 J/g. The copolyamide has a Tg greater by 15.2° C. with respect to that of PA 6.6.

This copolyamide exhibits a melt viscosity η of 37 Pa·s.

### EXAMPLE 3

### Preparation of a Polyamide PA 6.HIA and of a Blend PA 6.6/PA 6.HIA, 85/15 by Weight

A 51% by weight 6.HIA salt in water is produced by mixing a stoichiometric amount of hexamethylenediamine and 5-hydroxyisophthalic acid in water. 5623 g of 51% 6.HIA salt, 112.1 g of 99.5% 5-hydroxyisophthalic acid, 105 g of water and 3.3 g of antifoaming agent are subsequently introduced into a polymerization reactor.

The polyamide PA 6.HIA is manufactured according to a standard polymerization process of polyamide 6.6 type, with finishing for 30 minutes. The polymer obtained is cast in the rod form, cooled and formed into granules by cutting the rods. The polymer obtained is amorphous and exhibits a glass transition temperature of Tg=166.6° C.

The PA 6.6 and the PA 6.HIA thus prepared are blended in a proportion of 85/15 by weight by the molten route in a DSM MIDI 2000 microextruder (microcompounder) (15 cm³) at a temperature of 275° C. This blend exhibits a melt viscosity η of 35 Pa·s.

Another blend with a proportion of 50/50 by weight is also prepared. This blend exhibits a melt viscosity η of 10 Pa·s.

### EXAMPLE 4

### Preparation of a Polyamide PA 6.6 Phenol-Functionalized by a Monoacid-Phenol

135.2 g of N salt (0.52 mol), 9.41 g of 98% 4-hydroxyphenylacetic acid (0.06 mol), 10.87 g of a 32.4% aqueous solution of hexamethylenediamine (0.03 mol), 127.2 g of demineralized water and 2 g of an antifoaming agent are introduced into a polymerization reactor.

The polyamide is manufactured according to a standard polymerization process of polyamide 6.6 type with finishing for 30 minutes.

The polymer obtained is cast in the rod form, cooled and formed into granules by cutting the rods.

The polymer obtained exhibits the following characteristics:
CEG=103.3 meq/kg, AEG=29.4 meq/kg. The theoretical amount of phenol functional groups at the chain end, PEG, is calculated from the starting amounts introduced into the reactor. PEG=437 meq/kg. Mn=2×10⁶/(AEG+CEG+PEG)=3510 g/mol.

The polyamide PA 6.6 phenol-functionalized by 4-hydroxyphenylacetic acid is semicrystalline and has the following thermal characteristics: Tc=231.9° C., M.p.=259° C., ΔHf=81.5 J/g.

### EXAMPLE 5

### Preparation of the Composites

The different polymers under consideration are used in the powder form for the most fluid or otherwise in the film form. The powders are obtained by cryogenic grinding, either in dry ice or in liquid nitrogen. The films are produced by extrusion of granules on a Leistritz twin-screw extruder with a diameter of 34 and an L/D of 34 equipped with a flat die and a film-forming device (extruder flow rate of 10 kg/h, screw speed of 250 rpm, temperature of 270° C.). The gap between the lips of the die is 300 μm approximately for a width of 30 cm with a delivery rate of 3.2 m/min over rollers regulated at 115° C.: the films obtained have a thickness which varies between 160 and 180 μm (spools with a width of 300 mm).

The polymer films are cut out in the form of sheets with dimensions of 150×150 mm or 200×300 mm from the spools obtained above. It is the same for the reinforcing cloths.

The composite components are prepared by means of a Schwabenthan hydraulic press comprising two temperature-controlled plates (Polystat 300A): heating plates (heating resistances) and cooled plates (circulation of water). A metal mold having a cavity with dimensions of 150 mm×150 mm or 200×300 mm is used.

In order to produce a composite comprising 80% by weight (65% by volume) of glass fibers with the fabric with a grammage of 600 g/m², a preform composed of an alternating stack comprising 6 sheets of glass fabrics and, between each, either a sheet of polymer or uniformly distributed powder is introduced into the mold, the two outer layers being sheets of glass fabrics.

The temperature of the plates of the press is raised beforehand to 290° C., before the introduction of the preform. At this temperature, the pressure is applied between 1 and 50 bar and maintained at this value; ventings are rapidly carried out. The assembly is maintained at the same temperature and pressure, without venting. A series of ventings is again subsequently carried out and then the assembly is again maintained, still at the same temperature and pressure. The mold is then transferred onto the device comprising cooled plates and maintained at a pressure of between 1 and 50 bar.

The composite components thus obtained have a size of 150×150 mm or 200×300 mm and a thickness of approximately 2 mm.

### EXAMPLE 6

### Characterization of the Composites

One type of cycle was carried out: cycle of 5 min under a medium pressure of 15 to 50 bar (1 min under 15 bar, then 2 min under 50 bar and then 2 min under 50 bar). This time corresponds to the total duration of the cycle between bringing the mold to temperature and cooling under pressure.

The 150×150 mm or 200×300 mm sheets are cut up in order to obtain samples with dimensions of 150×20×2 mm.

A first series of samples is characterized immediately after manufacture (samples placed under a sealed covering, in order to keep them in a dry state RH0).

A conditioning treatment can also be carried out according to the standard ISO 1110, “Plastics-Polyamides-Accelerated conditioning of test specimens”: “RH50” state. The water content at equilibrium is obtained by conditioning the composite components with a cycle of 14 days at 70° C. under a residual humidity RH of 62%.

The mechanical properties were obtained at 23° C. and ambient humidity RH=50%.

The three-point bending tests at ambient temperature are carried out on parallelepipedal test specimens (150×20×2 mm), according to the standard ISO No. 14125, on a Zwick 1478 machine: distance between rods of 64 mm, crosshead velocity of 5 mm/min. The values for Young's elastic modulus E (GPa) and for max stress σ at peak (MPa) are measured and calculated.

Direct tension tests at ambient temperature are carried out on parallelepipedal test specimens (250×25×2 mm), according to the standard ASTM D3039/D3039M, on a Zwick 1478 machine: crosshead velocity of from 1 to 5 mm/min. The values for Young's elastic modulus E (GPa) and for max stress σ at peak (MPa) are measured and calculated.

The results are given in the following table 1:

TABLE 1
Results for the components manufactured according to
Medium pressure cycle (RH0/RH50)

| | Three-point bending | | Tension | |
|---|---|---|---|---|
| | Elastic | Max | Elastic | Max |
| Polyamide | modulus E | stress σ | modulus E | stress σ |
| used | (GPa) | (MPa) | (GPa) | (MPa) |
| PA C1 RH50 | 27 | 610 | 27 | 498 |
| RH0 | 29.1 | 650 | 29 | 520 |
| PA 3 (15%) | 29 | 600 | 28 | 550 |
| RH0 | | | | |
| PA 3 (50%) | 28.5 | 650 | — | — |
| RH0 | | | | |
| PA 2 RH0 | 28 | 590 | — | — |

In the case of a manufacturing cycle of 5 minutes under medium pressure, the mechanical performance obtained is high: max stress (peak) in bending of 550 to 650 MPa, for modulus values between 27 and 29 GPa.

For the modified polyamides comprising 6.HIA hydroxyaromatic units, a slight improvement in performance is observed for the breaking stress. The form of breaking in tension is markedly more sudden in the case of the unmodified polyamides.

### EXAMPLE 7

### Characterization of the Composites After Hygrothermal Aging

The samples prepared according to example 6 were subjected to hygrothermal aging. Aging of accelerated type was carried out by immersion of the samples in water at 80° C. for 8 days (accelerated test).

After aging, the test specimens were either tested as is or reconditioned by removal of the adsorbed water:

treatment at 80° C. under vacuum for 24 h (dry state: RH0).

The mechanical properties were measured at 23° C. and ambient humidity RH=50% (test specimens as is or at RH=0).

The results are given in the following table 2:

TABLE 2
Results for the components manufactured after
accelerated hygrothermal aging (80° C.), state as is and
reconditioning RH0

| | Three-point bending | | Tension | |
|---|---|---|---|---|
| | Elastic | Max | Elastic | Max |
| Polyamide | modulus E | stress σ | modulus E | stress σ |
| used | (GPa) | (MPa) | (GPa) | (MPa) |
| PA C1, as is | 25 | 340 | 26.8 | 290 |
| PA C1 - RH0 | 25 | 450 | 27 | 390 |
| PA 3 (15%), | 28.5 | 535 | 28 | 400 |
| as is | | | | |
| PA 3 (15%) | 29 | 580 | 28.5 | 480 |
| RH0 | | | | |
| PA 3 (50%), | 28.5 | 480 | — | — |
| as is | | | | |
| PA 2, as is | 26 | 510 | — | — |

In the case of the high-melt-flow polyamides not comprising 6.HIA hydroxyaromatic units, a decline in the mechanical performance, in particular in the max stress (breaking stress), is observed: the maximum stress measured in bending thus changes from 610 MPa (RH50) to 340 MPa (as is) or otherwise from 650 MPa (RH0) to 450 MPa (RH0), i.e. a decline of 45% (wet state) or 30% (RH0).

In the presence of 15% PA HIA, a marked improvement in the mechanical performance is observed after hygrothermal aging. The aging then brings about a limited decline in the mechanical strength in bending of 3% (PA 6.6/PA 6.HIA 85/15 blend) or 15% (PA 6.6/PA 6.HIA 50/50 blend).

A similar behavior is observed in direct tension: decline in the mechanical strength in tension limited to 7% for the PA 6.6/PA 6.HIA 85/15 blend (RH0).

1. A process for manufacturing a composite article, the process comprising:
a) impregnating a reinforcing cloth with a polyamide composition in a molten state, wherein the polyamide comprises hydroxyaromatic units chemically bonded to a chain of the polyamide, the composition comprising a novolac resin; and
b) cooling and subsequently recovering the composite article.

2. The process as defined by claim 1, wherein the polyamide composition exhibits a melt viscosity η of 1 Pa·s to 50 Pa·s.

3. The process as defined by claim 1, wherein the melt viscosity is measured using a plate/plate rheometer with a diameter of 50 mm under a stepwise shear sweep ranging from 1 s⁻¹ to 160 s⁻¹, by melting a film of polyamide with a thickness of 150 μm at a temperature of 25° C. to 30° C. above its melting point.

4. The process as defined by claim 1, wherein the polyamide is selected from the group consisting of a polyamide obtained by polycondensation of at least one linear aliphatic dicarboxylic acid with an aliphatic or cyclic diamine or between at least one aromatic dicarboxylic acid and one aliphatic or aromatic diamine, a polyamide obtained by polycondensation of at least one amino acid or lactam with itself, or a combination thereof and a (co)polyamide.

5. The process as defined by claim 1, wherein the polyamide is obtained by addition, before or during the polymerization of a polyamide monomer, a monomer of a diamine, a monomer of a dicarboxylic acid, a monomer of a monoamine or a monomer of a monocarboxylic acid type.

6. The process as defined by claim 1, wherein the polyamide is selected from the group consisting of a polyamide 6, a polyamide 6.6, a polyamide 6.10, a polyamide 11, a polyamide 12, a polyamide 6.12, a poly(m-xylylene adipamide), a polyamide 6.6/6.T, a polyamide 6.6/6.1, a blend thereof and a copolyamide thereof.

7. The process as defined by claim 1, wherein the polyamide comprising hydroxyaromatic units chemically bonded to the chain of the polyamide is obtained by modification of the polyamide with a hydroxyaromatic compound.

8. The process as defined by claim 1, wherein the polyamide comprising hydroxyaromatic units chemically bonded to the chain of the polyamide is obtained by addition in polymerization of a compound comprising hydroxyaromatic units in the presence of the monomers of the polyamide.

9. The process as defined by claim 7, wherein the hydroxyaromatic compound exhibits at least one functional group that reacts with the functional groups of the polyamide or of the monomers of the polyamide.

10. The process as defined by claim 7, wherein the hydroxyaromatic compound is represented by the following formula (I):
(HO)ₓ—Z—(F)ₙ (I)
in which:
Z is a polyvalent aromatic or an arylaliphatic hydrocarbon radical,
x is between 1 and 10,
F is an acid, an aldehyde, an amine or a ketone functional group that bonds to an acid or an amine functional group of the monomers of the polyamide, and
n is between 1 and 5.

11. The process as defined by claim 10, wherein Z is a polyvalent radical selected from the group consisting of: a benzene, a methylbenzene, a naphthalene, a biphenyl, a diphenyl ether, a diphenyl sulfide, a diphenyl sulfone, a ditolyl ether, a xylylene, a diethylbenzene and a pyridine.

12. The process as defined by claim 10, wherein the hydroxyaromatic compound is selected from the group consisting of: a 2-hydroxyterephthalic acid, a 5-hydroxyisophthalic acid, a 4-hydroxyisophthalic acid, a 2,5-dihydroxyterephthalic acid, a 4-hydroxyphenylacetic acid, a gallic acid, a L-tyrosine, a 4-hydroxyphenylacetic acid, a 3,5-diaminophenol, a 5-hydroxy-m-xylylenediamine, a 3-aminophenol, a 3-amino-4-methylphenol and a 3-hydroxy-5-aminobenzoic acid.

13. The process as defined by claim 1, wherein the reinforcing cloth is fibrous or a filamentary network, and wherein a yarn or a fiber of the fibrous or filamentary network is a yarn or a fiber formed of a material selected from the group consisting of carbon, glass, an aramid, a polyimide, a flax, a hemp, a sisal, a coir, a jute, a kenaf or a mixture thereof.

14. The process as defined by claim 1, wherein the polyamide composition is injected into a molding chamber comprising at least one reinforcing cloth in order to carry out the impregnation.

15. The process as defined by claim 1, wherein one or more reinforcing cloths and one or more films of polyamide are brought into contact and said impregnation is carried out by melting the polyamide.

16. The process as defined by claim 1, wherein one or more reinforcing cloths and powder of a polyamide are brought into contact and said impregnation is carried out by melting the polyamide.

17. The process as defined by claim 1, wherein said process is a pultrusion process.

18. The process as defined by claim 1, wherein the composite article comprises from 25% to 80% by volume of reinforcing cloth, with respect to the total weight of the article.

19. A composite article or preform obtained by the process as defined by claim 1.
